(19) United States
(12) Patent Application Publication
(10) Pub. No.: US 2020/0201268 A1
(43) Pub. Date: Jun. 25, 2020

(54) SYSTEM AND METHOD FOR GUIDING A SENSOR AROUND AN UNKNOWN SCENE

(71) Applicant: ABB Schweiz AG, Baden (CH)

(72) Inventors: Remus Boca, Simsbury, CT (US); Zhou Teng, Hartford, CT (US); Thomas Fuhlbrigge, Ellington, CT (US)

(21) Appl. No.: 16/720,538

(22) Filed: Dec. 19, 2019

Related U.S. Application Data
(60) Provisional application No. 62/781,778, filed on Dec. 19, 2018.

(51) Int. Cl. G05B 13/04; G05B 13/02; B25J 9/16; B25J 13/08

(52) U.S. Cl. CPC G05B 13/048; B25J 13/089; B25J 9/1697; G05B 13/0265

(57) ABSTRACT

A robotic system is provided to analyze sensor output data to generate and update a prediction model associated with a virtual scene in the workspace associated with the object.

### CROSS-REFERENCE TO RELATED APPLICATION

The present application claims the benefit of the filing date of U.S. Provisional Application Ser. No. 62/781,778 filed on Dec. 19, 2018, which is incorporated herein by reference.

### TECHNICAL FIELD

The present application generally relates to industrial robots with vision systems, and more particularly, but not exclusively, to systems and methods to generate a model of an unknown scene by moving a sensor around the robot workspace.

### BACKGROUND

Industrial robots are repeatable, accurate and robust machines to perform many tasks. When a vision system is integrated with a robot, the robot uses the vision system to scan its environment and produce a 3D model of the robot environment. The robot environment model is then input to many advanced functions such as: collision avoidance, motion planning, guidance, inspection, interaction with the operator, etc.

Typically the robot scan path is defined by a human operator. The scan path is specific for each robot task and it depends on the structure of the robot environment. However, the robot environment can change and a new scan path needs to be created. Depending on the scene structure and tasks, multiple robot scan paths might be required for the robot operation. Defining the robot path by the robot operator is time consuming, tedious, and usually is completed using trial and error.

Several sensor characteristics need to be considered when defining a robot scan path, such as field of view, optimal distance placement, accuracy, frame rate, etc. The robot scan path needs to be optimized based on the sensor type and characteristics, and this adds complexity when defining a scan path. If more than one sensor is used to scan a scene or if the robot system includes a positioner or track, the complexity of the scan path is increased and the human operator defining a path needs to consider multiple criteria at the same time.

Some existing systems have various shortcomings relative to certain applications. Accordingly, there remains a need for further contributions in this area of technology.

### SUMMARY

Industrial robots disclosed herein are enhanced with vision systems to provide adaptability and flexibility in their operations. A vision system is integrated with a robot that is operable move one or more visual sensors around the robot workspace and generate a 3D model of the scene. A learning algorithm for a learning engine is proposed to control simulation environments with random robot scenes that include different types of scene objects, to move a vision sensor(s) around the scene to model the scene, and build a model that predicts where to move the vision sensor(s) next to maximize scene coverage. This learned model can then be used at production time to safely and efficiently move the visual sensor(s) around a scene in the robot workspace.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE FIGURES

The features, aspects, and advantages of the present disclosure will become better understood with regard to the following description, appended claims, and accompanying drawings where:

FIG. 1 is a schematic illustration of a robot system according to one exemplary embodiment of the present disclosure.

FIG. 2 is a schematic flow diagram illustration of a procedure for generating a prediction model for an unknown scene in the robot workspace according to one exemplary embodiment of the present disclosure.

### DETAILED DESCRIPTION OF THE ILLUSTRATIVE EMBODIMENTS

For the purposes of promoting an understanding of the principles of the application, reference will now be made to the embodiments illustrated in the drawings and specific language will be used to describe the same. It will nevertheless be understood that no limitation of the scope of the application is thereby intended. Any alterations and further modifications in the described embodiments, and any further applications of the principles of the application as described herein are contemplated as would normally occur to one skilled in the art to which the application relates.

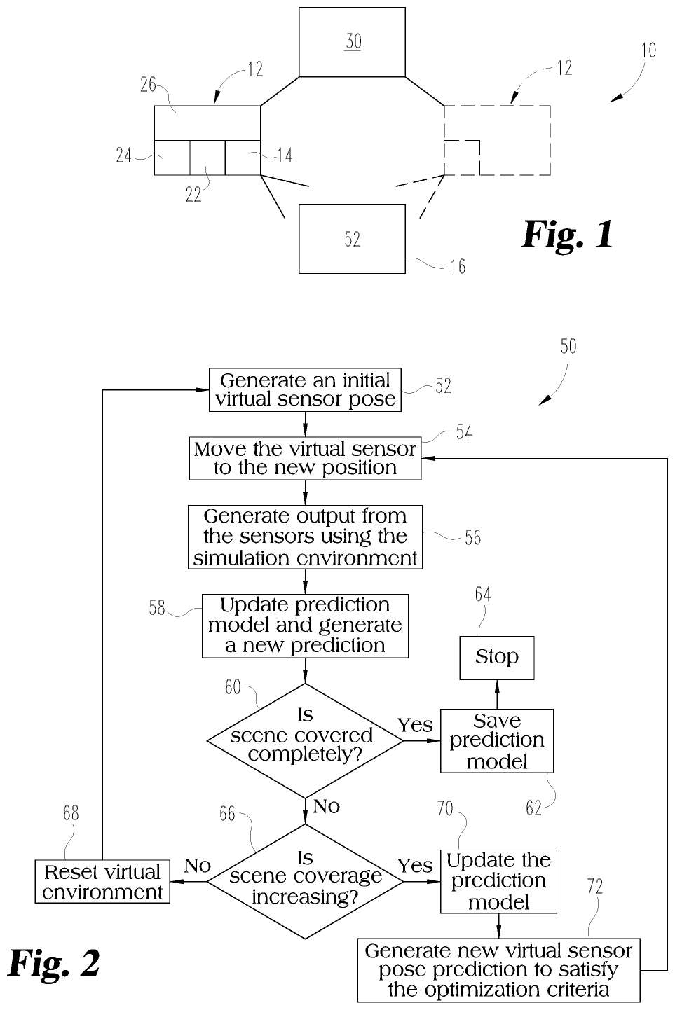

Referring to FIG. 1, an illustrative robot system 10 is shown schematically. It should be understood that the robot system 10 shown herein is exemplary in nature and that variations in the robot system 10 are contemplated herein. The robot system 10 can include at least one robotic cell 12 with a robot (including for example a robot arm 22, a robot tool 24, and a robot controller 26), and one or more objects 16 that are handled, observed or otherwise processed by robotic cell 12 in the workspace of the robotic cell 12.

The robot system 10 includes a sensing system 14 with one or more sensors to virtually and/or actually sense the areas of interest around the object(s) 16. In one embodiment, the sensing system 14 includes one or more vision sensors that can be static and/or mounted on a robot of robotic cell 12. The vision sensor(s), also called virtual sensors herein, are movable around the robot workspace to generate a three-dimensional (3D) model of the scene around object 16 and generate and learn a prediction model for movement of the sensing system 14 to maximize scene coverage. Details about the functions and components needed to learn a prediction model that outputs the next position of one or more sensors to maximize scene completeness are provided below.

The robot system 10 is operable to create a simulation environment with vision sensors for a random scene. A random scene means different objects can be placed in random positions in the robot workspace, although the position should be physically logical. The simulation environment includes realistic physical interactions/physics engine algorithms so that the interactions between different objects can be modeled and sensed by the robot system 10. There is no limit to the category of objects or the complexity of the structure of the scene in the robot workspace.

Some objects need to have the possibility to update their positions in the workspace. The virtual or vision sensors need to be able to render the virtual environment and generate sensor output/measurement. The expected output is similar to the output expected from 2D or 3D vision sensors. The virtual sensors have similar characteristics as the real visual sensors, such as: field of view, working range, noise and accuracy models, and frame rate so that the synthetic or virtual visual data is similar to data obtained from a real visual sensor.

The robot system 10 further includes a learning engine 30 in communication with robot controller 26, or as a part of robot controller 26, to control the virtual scene, the objects in the scene, and the virtual sensors of sensing system 14. Learning engine 30 and/or robot controller 26 can include a CPU, a memory, and input/output systems that are operably coupled to the robotic cell 12. The learning engine 30 and/or robotic cell 12 are operable for receiving and analyzing data such as images captured by the one or more sensors of sensing system 14. In some forms, the learning engine 30 and/or robot controller 26 are defined within a portion of one or more of the robotic cells. The learning engine 30 specifies the object and movement of the virtual sensors of sensing system 30. The motion sequence is generated by the control function of learning engine 30 and provided to the simulation environment to update the positions of the object(s) 16 in the workspace. The control function of learning engine 30 receives the object positions from the prediction model for the virtual sensors and tracks the positions for the other objects.

The learning engine 30 is also operable to generate sensor output data from the scene and sensor output processing for scene completeness. After the motion of the virtual sensors is completed in the simulation, the virtual sensors render the scene and generate visual data. The visual data from the virtual sensors is as similar as possible to the actual scene. The rendering engines implement light interaction with objects/materials to generate realistic sensor outputs.

The learning engine 30 is also operable to update the prediction model and generate new predictions for the virtual sensor. After the virtual sensor outputs are generated, the scene completeness is evaluated as a score and the score is passed to the prediction model. The prediction model assimilates the score and generates a new update for the sensor position. The new sensor positions are sent to the control functions for the robot controller 26. The scene completeness is one criteria that can be defined. Other criteria for determining a scene is complete or incomplete can include, for example, a search for an object in the scene, finding area(s) that are not accessible via sensor positions that have been employed, an area that is behind a specific object, etc.

The learning engine 30 repeats the updating process until the scene is completely defined. The steps described above can be repeated until the evaluation criteria is satisfied, such as a 3D scene model being completely generated.

The robot system 10 uses the prediction model to guide a real sensor in the scene until the scene 3D model is defined. The model defined by the learning engine as discussed above is used by a real robot to move a sensor safely and efficiently around an object 16 and generate a 3D model of a real scene in the workspace. The robot scan path is then saved for later use.

One advantage of the system and method describe above is that prior information about the real scene is not necessary. Geometric structure of the man-made objects have common structures such as edges, corners, cliffs, holes and so on, and the prediction model learns how to predict sensor motion when these geometrically common structures are presented in the current visual data.

The 3D visual data is an important input to the prediction model. The visual data can be input directly from the visual sensor or indirectly from 2D images, and the 3D data is used by the prediction model. The workflow for the training of a scene is presented in the flow diagram of FIG. 2. The same sequence is executed for many different scenes to create a prediction model that can work for any man-made or industrial robot environment.

In FIG. 2, the procedure 50 includes an operation 52 to generate an initial virtual sensor pose, and an operation 54 to move the virtual sensor to a new position. Procedure 50 continues at operation 56 to generate output from the sensors using the simulation environment.

Procedure 50 continues at operation 58 to update the prediction model and generate a new prediction for the sensors. After the sensor outputs are generated, the scene completeness or coverage can be evaluated based on sensor output, and/or as a score and the score is passed to the prediction model. At conditional 60 it is determined if the scene is covered completely. If conditional 60 is YES, procedure 50 continues at operation 62 to save the prediction model and then stops at 64.

If conditional 60 is NO, procedure 50 continues at conditional 66 to determine if the scene coverage is increasing. If conditional 66 is NO, procedure 50 continues at operation 68 to reset the virtual environment and returns to operation 52. If conditional 66 is YES, procedure 50 continues at operation 70 to update the prediction model. Procedure 50 then continues at operation 72 to generate a new virtual sensor pose prediction to satisfy certain predetermined criteria, such as optimization criteria, and returns to operation 54 to move the virtual sensor to a new position.

The present system and method simplifies the teaching of a robot scan path and enables the automation of the scene discovery to generate a prediction model to predict where to move a sensor in a scene to maximize scene completeness. The prediction model provides a new position regarding where to move one or more sensors to maximize scene completeness based on the current sensor output visual data/image(s).

This method and system employs a simulation environment with virtual sensors and a random scene and a learning engine. The learning engine is operable to control the virtual scene, the objects in the scene, and the virtual sensors. The learning engine generates sensor output data from the scene and sensor output processing for scene completeness. The learning engine updates the prediction model and generates new predictions for the sensor, and repeats until the scene is completely defined. A real robot uses the prediction model to guide a real sensor in the scene until the scene 3D model is defined, and the robot scan path is saved for later use.

The robot scan path is automatically generated so the robot can autonomously discover an unknown scene. A generic prediction model is generated that is applicable to many unknown scenes. The prediction model can be calculated and updated continuously based on simulation and real robot data, and can be used to guide a human operator that moves a sensor around a scene by displaying the next sensor position to the operator, and the operator tries to match the displayed position during operation of the robot.

According to one aspect of the present disclosure, a system includes a robotic cell including a sensing system, an object within a workspace of the robotic cell, and a learning engine configured to analyze sensor output data to generate and update a prediction model associated with a virtual scene in the workspace associated with the object. The robotic cell is operable to use the prediction model to guide a sensor around the workspace.

In one embodiment, the robotic cell includes a robot. In one embodiment, the robot includes a robot arm and a robot tool.

In one embodiment, the robot cell includes a robot controller in communication with the learning engine.

In one embodiment, the sensing system includes at least one sensor that is movable around the workspace to provide the sensor output data to generate a three-dimensional virtual scene. In one embodiment, the learning engine is configured to control the movement of the at least one sensor.

In one embodiment, the learning engine is configured to analyze sensor output data to generate and repeatedly update the prediction model.

According to another aspect of the present disclosure, a method includes generating an initial scene of a simulation environment with a virtual sensor at a first position in a simulation environment; moving the virtual sensor to a second position in the simulation environment; generating a prediction model with data from the virtual sensor in the second position regarding coverage of the scene in the simulation environment; and in response to the scene not being sufficiently covered and scene coverage increasing from the first position to the second position, updating the prediction model by moving the virtual sensor to another position in the simulation environment and obtaining additional data from the virtual sensor.

In one embodiment, the method includes determining the scene coverage is complete and saving the updated prediction model.

In one embodiment, the method includes determining the scene coverage is decreasing and resetting the simulation environment. In one embodiment, the method includes, in response to resetting the simulation environment: generating another initial scene of the simulation environment with the virtual sensor at a third position in the simulation environment; moving the virtual sensor to a fourth position in the simulation environment; generating the prediction model with data from the virtual sensor in the fourth position regarding coverage of the scene in the simulation environment; and in response to the scene not being sufficiently covered and scene coverage increasing from the third position to the fourth position, updating the prediction model by moving the virtual sensor to another position in the simulation environment and obtaining additional data from the virtual sensor.

In one embodiment, the method includes determining the scene coverage is increasing and before updating the prediction model. In one embodiment, the method includes generating a new sensor pose prediction to satisfy predetermined criteria before moving the virtual sensor to a third position.

In one embodiment, the virtual sensor is part of a robotic cell. In an embodiment, the robotic cell includes a robot. In an embodiment, the robot includes a robotic arm and a robot tool. In an embodiment, the prediction model is generated with a learning engine and robotic cell includes a robot controller in communication with the learning engine.

In one embodiment, the method includes updating the prediction model by moving the virtual sensor to another position in the simulation environment and obtaining additional data from the virtual sensor in response to detection of one or more areas in the simulation environment that are blocked by an object.

In an embodiment, the method includes updating the prediction model by moving the virtual sensor to another position in the simulation environment and obtaining additional data from the virtual sensor in response to detection of one or more areas in the simulation environment that are not accessible by the virtual sensor.

In an embodiment, the scene is a three-dimensional model of the simulation environment.

While the application has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. A system comprising:
a robotic cell including a sensing system;
an object within a workspace of the robotic cell; and
a learning engine configured to analyze sensor output data to generate and update a prediction model associated with a virtual scene in the workspace associated with the object, wherein the robotic cell is operable to use the prediction model to guide a sensor around the workspace.

2. The system of claim 1, wherein the robotic cell includes a robot.

3. The system of claim 2, wherein the robot includes a robot arm and a robot tool.

4. The system of claim 1, wherein the robot cell includes a robot controller in communication with the learning engine.

5. The system of claim 1, wherein the sensing system includes at least one sensor that is movable around the workspace to provide the sensor output data to generate a three-dimensional virtual scene.

6. The system of claim 5, wherein the learning engine is configured to control the movement of the at least one sensor.

7. The system of claim 1, wherein the learning engine is configured to analyze sensor output data to generate and repeatedly update the prediction model.

8. A method, comprising:
generating an initial scene of a simulation environment with a virtual sensor at a first position in a simulation environment;
moving the virtual sensor to a second position in the simulation environment;
generating a prediction model with data from the virtual sensor in the second position regarding coverage of the scene in the simulation environment; and
in response to the scene not being sufficiently covered and scene coverage increasing from the first position to the second position, updating the prediction model by moving the virtual sensor to another position in the simulation environment and obtaining additional data from the virtual sensor.

9. The method of claim 8, further determining the scene coverage is complete and saving the updated prediction model.

10. The method of claim 8, determining the scene coverage is decreasing and resetting the simulation environment.

11. The method of claim 10, further comprising, in response to resetting the simulation environment:
generating another initial scene of the simulation environment with the virtual sensor at a third position in the simulation environment;
moving the virtual sensor to a fourth position in the simulation environment;
generating the prediction model with data from the virtual sensor in the fourth position regarding coverage of the scene in the simulation environment; and
in response to the scene not being sufficiently covered and scene coverage increasing from the third position to the fourth position, updating the prediction model by moving the virtual sensor to another position in the simulation environment and obtaining additional data from the virtual sensor.

12. The method of claim 8, further comprising determining the scene coverage is increasing and before updating the prediction model.

13. The method of claim 12, further comprising generating a new sensor pose prediction to satisfy predetermined criteria before moving the virtual sensor to a third position.

14. The method of claim 8, wherein the virtual sensor is part of a robotic cell.

15. The method of claim 8, wherein the robotic cell includes a robot.

16. The method of claim 15, wherein the robot includes a robot arm and a robot tool.

17. The method of claim 15, wherein the prediction model is generated with a learning engine and robotic cell includes a robot controller in communication with the learning engine.

18. The method of claim 8, further comprising updating the prediction model by moving the virtual sensor to another position in the simulation environment and obtaining additional data from the virtual sensor in response to detection of one or more areas in the simulation environment that are blocked by an object.

19. The method of claim 8, further comprising updating the prediction model by moving the virtual sensor to another position in the simulation environment and obtaining additional data from the virtual sensor in response to detection of one or more areas in the simulation environment that are not accessible by the virtual sensor.

20. The method of claim 8, wherein the scene is a three-dimensional model of the simulation environment.
